(19) United States
(12) Patent Application Publication
(10) Pub. No.: US 2010/0207357 A1
(43) Pub. Date: Aug. 19, 2010

(54) COUPLER CONVERTER ADAPTER

(76) Inventors: William Cory Hathcock, Lenoir, NC (US); Mitchell Olin Setzer, SR., Lenoir, NC (US); William Monty Simmons, Lenoir, NC (US); Larry Richard Setzer, SR., Lenoir, NC (US)

Correspondence Address: SIMMONS PATENTS, P.O. BOX 1560, LENOIR, NC, 28645, US

(21) Appl. No.: 12/705,963

(22) Filed: Feb. 15, 2010

Related U.S. Application Data
(60) Provisional application No. 61/152,747, filed on Feb. 16, 2009.
(60) Provisional application No. 61/169,065, filed on Apr. 14, 2009.

(51) Int. Cl. B60D 1/07

(52) U.S. Cl. 280/416.1

(57) ABSTRACT

The invention comprises a coupler converter/adapter for use with vehicles to be towed such as utility trailers. The coupler converter is configured with a first attachment mechanism configured for being associated with a vehicle to be towed's coupling device. The coupler converter is further configured with a second attachment mechanism that is different from the first attachment mechanism, such second attachment mechanism configured for being associated with a trailer hitch associated with a tow vehicle. The coupler converter is configured to be stowed on the utility trailer when not being used. In one configuration, the coupler converter can be used as a coupler lock to deter theft.

### CLAIM TO PRIORITY

This application claims priority to application No. 61/152,747, filed Feb. 16, 2009, and application No. 61/169,065, filed Mar. 14, 2009, the entire contents of which are incorporated herein by this reference for all that they disclose.

### TECHNICAL FIELD OF THE INVENTION

The present invention relates to an apparatus adapting/converting a trailer tongue having a first coupler type to a second coupler type.

### BACKGROUND OF THE INVENTION

Generally speaking, a trailer is an unpowered vehicle configured for being pulled by a powered vehicle. Such trailers are used for the transportation of items such as goods and materials. Trailers suitable for personal use come in many shapes and sizes and are often named according to their intended use (i.e. motorcycle trailer, boat trailer, bicycle trailer, etc.). Such trailers generally require no special training or license or permit to own and use and can be pulled by a common pickup truck having an appropriate tow hitch.

A trailer is typically associated with a coupling configured for being associated with a trail hitch (a.k.a. “tow-hitch”). A trailer hitch is a device attached to the chassis of a vehicle and configured for being associated with a coupling associated with a trailer. In the United States trailer hitches come in two basic types, Fixed-drawbar type hitches and receiver type hitches. Fixed-drawbar hitches are typically built as one piece, have an integrated hole for the trailer ball, and are generally not compatible with aftermarket hitch accessories. Receiver-type hitches consist of a portion that mounts to the frame of the vehicle that has a rearward facing opening that accepts removable ball mounts, hitch bike racks, cargo carriers, or other hitch mounted accessories.

Prior art trailers typically come configured with a coupler for being associated with one type trailer hitch, however, there are a plurality of trailer hitch types and sizes. One type of straight tongue trailer coupler hitch is configured for being associated with one of a plurality ball hitch sizes such as a 3 inch, 2 5/16 inch, 2½ inch, and 1⅞ inch ball. It should be noted that if a trailer has an prior art 3 inch ball socket coupler, for example, it can only be towed safely associated with a tow vehicle having a 3 inch ball hitch.

Instead of a ball and ball socket type of system, a trailer may come with a second type of coupler system called a Lunette ring and pintle hook system. A Lunette ring is a coupling that is associated with a trailer as described above. Such Lunette right is configured for being associated with pintle hook (associated with a tow vehicle). A pintle hook and lunette ring make a more secure coupling, particularly desirable on rough terrain, compared to ball and ball socket system. Additionally, most people find making a secure connection between a Lunette ring and a pintle hook to be much easier compared to making a secured connection between a ball and ball socket as a secured connect ban be visibly verified.

As a result of the various types of couplers a trailer might have, the receiver-type hitches described above are far more common than fixed-drawbar couplers. Additionally a person may own many types of trailers having different coupler types, pull different types of trailers, or purchase a new trailer perhaps having a coupler different than a previously owned trailer. Consequently, a receiver-type hitch was developed that could be easily associated with a variety of hitch types so that the hitch type can be quickly changed to match the coupler on a trailer to be towed.

Such an arrangement works well but it has it disadvantages. First, many people may own several trailers such as a light duty 8 foot trailer, an enclosed 26 foot trailer, a towable wood splitter, and other types of tow vehicles. The light duty trailer is likely to have a 2″ ball, the 26 foot enclosed trailer is likely to have a 2 5/16 inch ball and the towable wood splitter is likely to have a 1⅞ inch ball. In addition, one may own a trailer with a Lunette ring. Indeed, as noted above, most users of trailers concede that the Lunette ring/pintle hook configuration is the better design in that it makes a more secure towing connection and hooking up a pintle hook to a Lunette is much easier than hooking up a ball hitch with a coupler.

Second, a person that owes several types of trailers including a trailer with a Lunette ring will typically be required to have at least two hitches. Some pintle hook ball hitch combination devices have been developed to allow a user to tow a trailer with a Lunette ring and a trailer with a particular size coupler without making any changes to the towing system. For example, one can purchase a tow hitch that is a pintle hook where the “hook” comprises a 2″ ball. Thus a user can tow a trailer with a 2″ coupler and a trailer with a Lunette ring. If such a person has a third tow vehicle with a different ball size, he must purchase a second hitch and perhaps more for more trailers.

Third, if one wishes to loan a trailer to another, or borrow a trailer from another, the borrowed trailer coupler may not match the tow vehicle trailer hitch. Thus, the owner of the tow vehicle will likely be required to switch something in the towing system.

Such problems with the prior art system typically require a person to have at least two trailer hitch devices. Having two different types of hitches is not desirable for several reasons.

First, such trailer hitches are heavy and are typically secured in place by a drawbar lock. Such makes changing a trailer hitch a nuisance, requires one to keep up with yet another key, and takes time when a user is typically in a hurry. Second, the trailer hitch that is not being used must be hauled around and is subject to being borrowed, stolen, lost, or for whatever reason being unavailable to the owner when needed.

While the prior art has provided numerous trailer hitch devices (for the tow vehicle), what the prior art has failed to address is configuring the trailer (the vehicle being towed) with a converter. What is needed is a trailer tongue device that converts the trailer coupler so that such a trailer may be pulled/towed by more than one type of trailer hitch. In addition, a converter is needed that stays with the trailer when not in use avoiding the need to store such a device.

Another area of interest to trailer owners is theft prevention. Coupler locks have been developed and are commercially available for securing a trailer. What is needed is a coupler converter that can also be used as a coupler lock to prevent theft when the trailer is not being used.

### SUMMARY

Some of the objects and advantages of the invention will now be set forth in the following description, while other objects and advantages of the invention may be obvious from the description, or may be learned through practice of the invention.

Broadly speaking, a principle object of the present invention is to provide an apparatus for converting a first coupler type defined by a coupler associated with a vehicle to be towed to a second coupler type.

Yet another object of the invention is to provide for an apparatus for selectably converting a first coupler type defined by a coupler associated with a vehicle to be towed to a second coupler type where a user can select which coupler type to use without the use of tools.

Still another object of the invention is to provide for an apparatus for selectably converting a first coupler type defined by a coupler associated with a vehicle to be towed to a second coupler type where a user can configure such apparatus so that neither the first coupler type nor the second coupler type can be used thereby providing a security feature.

Yet another object of the invention is to provide for an apparatus for selectably converting a first coupler type defined by a coupler associated with a vehicle to be towed to a second coupler type where the converter is stored on the vehicle to be towed when not in use.

Additional objects and advantages of the present invention are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments of this invention without departing from the spirit and scope thereof, by virtue of the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, of this invention may include various combinations or configurations of presently disclosed features or elements, or their equivalents (including combinations of features or parts or configurations thereof not expressly shown in the figures or stated in the detailed description).

For the purposes of this document two or more items are “mechanically associated” by bringing them together or into relationship with each other in any number of ways including a direct or indirect physical connection that may be releasable (snaps, rivets, screws, bolts, etc.) and/or movable (rotating, pivoting, oscillating, etc.). Similarly, two or more items are “electrically associated” by bringing them together or into relationship with each other in any number of ways including: (a) a direct, indirect or inductive communication connection, and (b) a direct/indirect or inductive power connection.

For one embodiment, a coupler converter for converting a coupler associated with a Vehicle-To-Be-Towed (VTBT) having a first coupler type to a second coupler type. For example, such first coupler type may be the well known 2.0 inch ball socket welded to the draw bar of a trailer and said second coupler type may be a Lunette ring (or a 2.5 inch ball socket, etc). The coupler converter comprises a converter body and a converter-body-coupler (e.g. a Lunette ring, a 1.5 inch ball socket, a 2.5 inch ball socket, etc.) wherein said converter-body-coupler (a.k.a the second coupler type) is one of (a) mechanically associated with said converter body, and (b) integral to said converter body. The converter-body-coupler is suitable for being mechanically associated with a hitch associated with a tow vehicle. The converter coupler may further comprise a converter-to-coupler attachment mechanism, said converter-to-coupler attachment mechanism suitable for being mechanically associated with the first coupler type. For example, if said first coupler type is a 1.5 inch ball socket, said converter-to-coupler attachment mechanism may be a 1.5 inch ball (or any other device that can form a secure mechanical association between said converter body and said first coupler type). Such a feature, while optional for some embodiments of the invention, adds stability to the system.

Ideally, the coupler converter body defines a rectangular shaped body comprising a first end associated with a converter-body-coupler (i.e. said second coupler type; e.g. Lunette ring), said converter body extending from said converter-body-coupler to an opposing distal second end, and wherein said body comprises a c-body (coupler body) interfaced disposed between said first end and said distal second end, said c-body interface suitable for being removably associated with one of (a) at least one attachment point defined by said VTBT coupler (note the VTBT's coupler defines the first coupler type), and (b) at least one attachment point defined by an attachment-plate mechanically associated with said VTBT.

The c-body interface is disposed along said converter body to provide for a first, second and third configuration (or mode). For the first converter-coupler-mode or configuration, the converter-to-coupler attachment mechanism is associated with the first coupler type defined by the VTBT's coupler and said converter-body-coupler is used for associating the VTBT to a hitch associated with a tow vehicle (the “tow vehicle” is the vehicle that does the towing such as a truck). For the second converter-coupler-mode/configuration, the converter-to-coupler attachment mechanism is not associated with the first coupler type defined by the VTBT's coupler and said first coupler type is used for associating the VTBT to a hitch associated with a tow vehicle. Preferably, for such configuration, the converter is stowed on the VTBT. For the third converter-coupler-mode/configuration, neither the first coupler type defined by said VTBT coupler nor the converter-body-coupler is used for associating the VTBT to a hitch associated with a tow vehicle and prevents any conventional use of said VTBT coupler (which provides a security feature).

Yet another embodiment of the invention relates to an improved trailer coupler for coupling a vehicle to be towed (VTBT) to a tow vehicle. The improved coupler comprises a coupler body defining a support-structure-interface suitably configured for being associated with a support structure associated with a VTBT. A coupler-mechanism that is one of (a) associated with said coupler body and (b) integral to said coupler body defines the coupler type and is suitably sized for being associated with a first hitch type (associated with a tow vehicle). For example, where the hitch type is a 2″ ball hitch, the coupler-mechanism may a 2″ ball socket. The coupler body further defines a converter-interface section comprising at least one converter-attachment-point configured for being associated with a coupler converter as defined above.

As described above, the location of said at least one converter-attachment-point within said converter-interface section is selected so that a converter-coupler can be associated with said coupler in one of three modes. In a first mode the coupler-mechanism is used to associate said VTBT to a tow vehicle. In a second mode, a converter-coupler associated with said coupler is used to associate said VTBT to a tow vehicle. In a third mode, neither a converter-coupler nor the coupler-mechanism is used to associate said VTBT to a tow vehicle and further prevents conventional use of said coupler-mechanism (thereby providing a security feature).

One exemplary method of coupling a VTBT to a tow vehicle is now disclosed. The first step is to provide a coupler body defining a first attachment point configured for being associated with a support structure for a VTBT. The coupler body further defines a first attachment mechanism suitable for being releasably associated with a first hitch type associated with a tow vehicle. The coupler body further defines a second attachment point configured for being releasably associated with a converter-body-coupler. The method further comprises the steps of providing a converter-body-coupler comprising a converter-body defining a converter-body-coupler-interface suitably configured for being associated with said second attachment point. Said converter-body-coupler further comprising a second attachment mechanism configured for being associated with a second hitch type associated with a tow vehicle.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a side view of a utility trailer associated with a coupler converter according to one exemplary embodiment of the inventions;

FIG. 1a is a front elevated perspective close up view of the coupler converter depicted in FIG. 1 where the coupler converter is positioned in a first configuration;

FIG. 1b is a front elevated perspective close up view of the coupler converter depicted in FIG. 1 where the coupler converter is positioned in a second configuration;

FIG. 1c is a front elevated perspective close up view of the coupler converter depicted in FIG. 1 where the coupler converter is positioned in a third configuration;

FIG. 2 is an exploded view of the exemplary coupler converter depicted in FIG. 1;

FIG. 3a is a side view of the exemplary coupler converter depicted in FIG. 1a;

FIG. 3b is a side view of the exemplary coupler converter depicted in FIG. 1b;

FIG. 3c is a side view of the exemplary coupler converter depicted in FIG. 1c;

FIG. 4a is a top view of the exemplary coupler converter depicted in FIG. 1a;

FIG. 4b is a top view of the exemplary coupler converter depicted in FIG. 1b;

FIG. 4c is a top view of the exemplary coupler converter depicted in FIG. 1c;

FIG. 5 is an exemplary side perspective view of an improved coupler comprising a converter attachment section according to one exemplary embodiment of the invention;

FIG. 6 is a side elevated rear perspective view of one alternative embodiment of the invention comprising a swivel joint;

FIG. 7 is an exploded view of the exemplary embodiment of the invention depicted in FIG. 6;

FIG. 8 a side front perspective view of a coupler converter depicted in FIG. 6 in a first configuration/mode;

FIG. 9 is an elevated front perspective view of the coupler converter depicted in FIG. 8 presenting a swivel function;

FIG. 10 is a side perspective view of the coupler converter depicted in FIG. 6 and a second configuration/mode;

FIG. 11 is a side perspective view of another alternative embodiment of the invention;

FIG. 12 is a side perspective view of yet another alternative embodiment of the invention having no rear attachment point;

FIG. 13 is a side perspective view of another alternative embodiment of the invention having a rear “clamping” feature;

FIG. 14 is a side view of yet another alternative embodiment of the invention comprising a adjustable one piece interface-plate; and

FIG. 15 is an exploded view of the embodiment depicted in FIG. 14.

Repeat use of reference characters throughout the present specification and appended drawings is intended to represent the same or analogous features or elements of the present technology.

### DETAILED DESCRIPTION

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features, and aspects of the present invention are disclosed in or may be determined from the following detailed description. Repeat use of reference characters is intended to represent same or analogous features, elements or steps. It is to be understood by one of ordinary skill in the art that the present discussion is a description of exemplary embodiments only, and is not intended as limiting the broader aspects of the present invention.

For the purposes of this document two or more items are “mechanically associated” by bringing them together or into relationship with each other in any number of ways including a direct or indirect physical connection that may be releasable (snaps, rivets, screws, bolts, etc.) and/or movable (rotating, pivoting, oscillating, etc.) Similarly, two or more items are “electrically associated” by bringing them together or into relationship with each other in any number of ways including: (a) a direct, indirect, wireless, or inductive communication connection, and (b) a direct/indirect or inductive power connection. Additionally, while the drawings may illustrate various electronic components of a system connected by a single line, it will be appreciated that such lines may represent one or more signal paths, power connections, electrical connections and/or cables as required by the embodiment of interest.

While this section of the specification may contain headers, such headers are simply place markers and do not form a part of the specification and are not to be used in the construction of the specification.

While the particulars of the present invention and associated technology may be adapted for use with any type of apparatus for transporting items, the examples discussed herein are primarily in the context of a coupler converter for use with utility trailers.

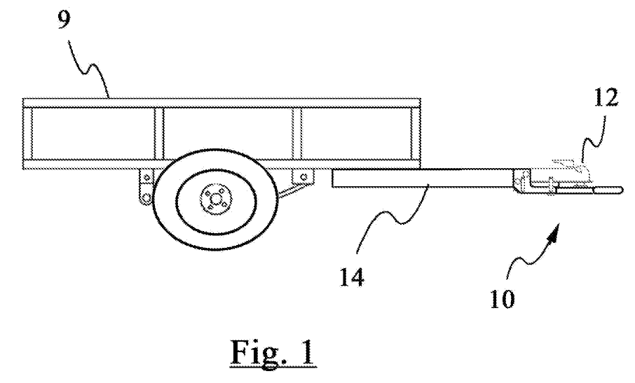

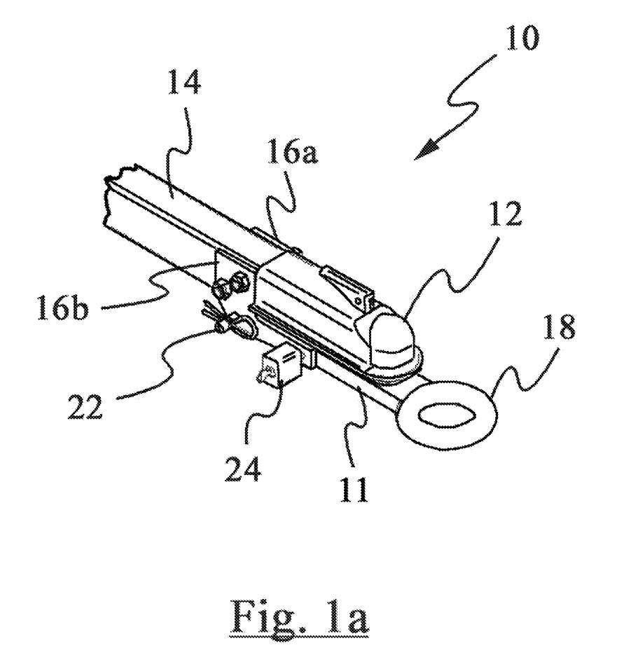

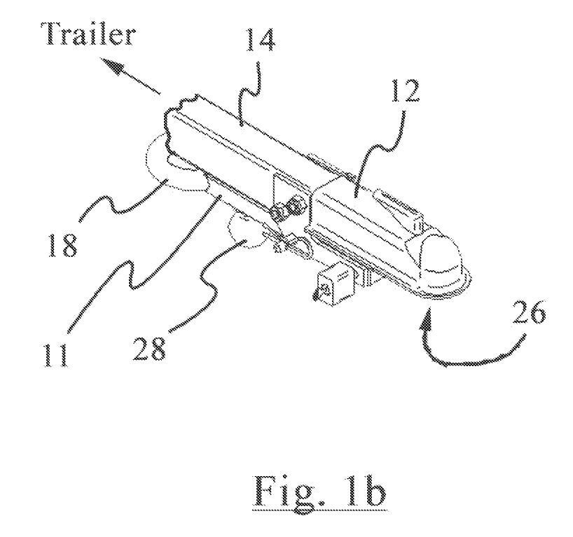

Referring now to FIG. 1, a side view of one embodiment of a coupler converter (10) associated with a trailer's (9) tongue coupler (12) is presented. As previously noted, there are many types and sizes of tongue couplers for associating a vehicle to be towed (hereafter “VTBT”) to a tow vehicle. For the purposes of this document, a straight tongue trailer coupler configured to receive a 3 inch ball hitch is a different type of coupler compared to a straight tongue coupler configured to receive a different size ball hitch (such as a 2 5/16 inch, 2½ inch, and 1⅞ inch balls). Tongue coupler (12) is mechanically associated with drawbar (14) of utility trailer (9) and defines a first coupler type for associating trailer (9) (VTBT) to a hitch associated with a tow vehicle. As depicted in FIG. 1, coupler converter (10) is configured to convert (or adapt—convert/adapt mean the same thing for this document) tongue coupler (12) from a first coupler type to a second coupler type. For the presently preferred embodiment, the first coupler type is a 1⅞ inch ball hitch socket and a second coupler type is a Lunette ring. As noted above, a Lunette ring is a type of trailer coupling device that works in combination with a pintle hook (associated with a tow vehicle).

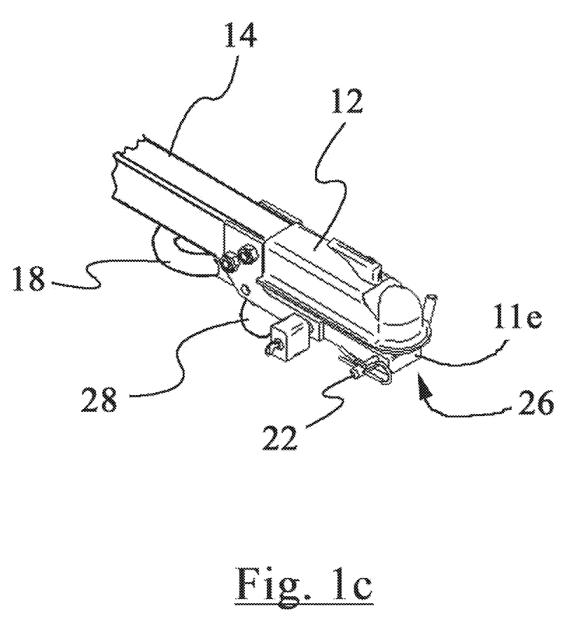

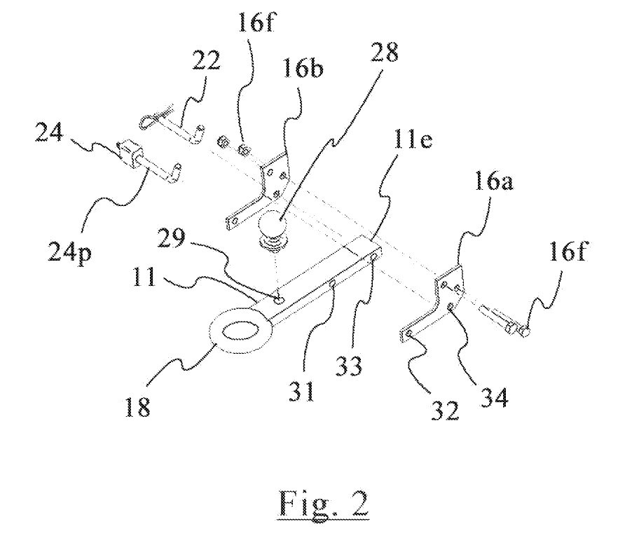

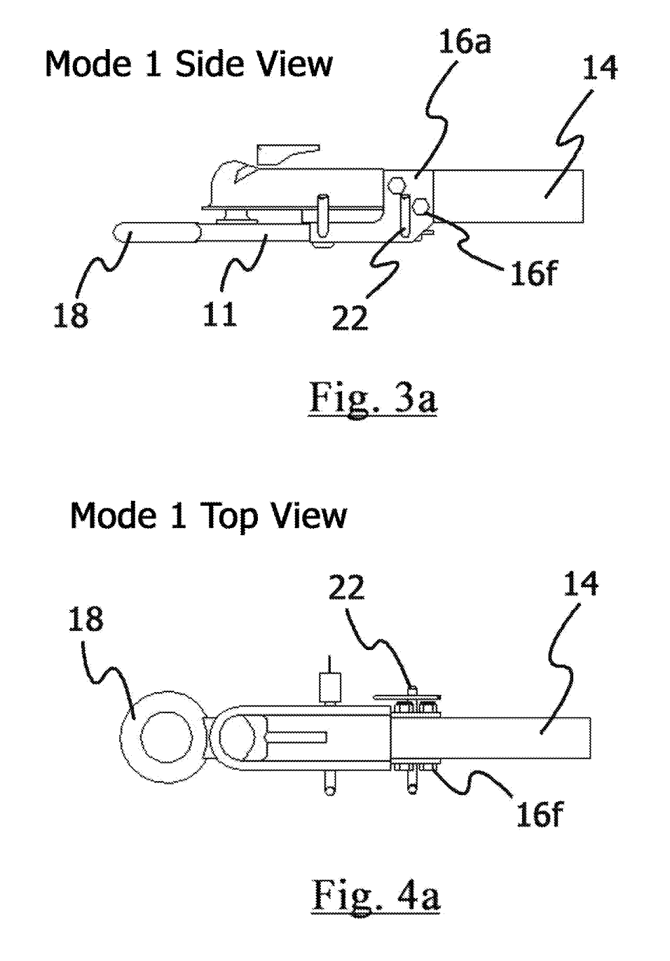

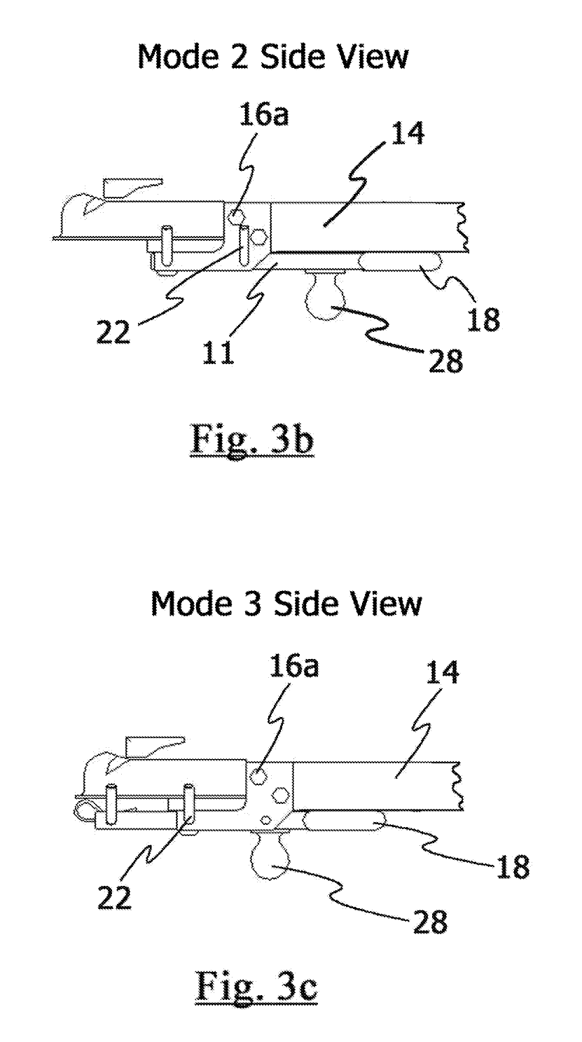

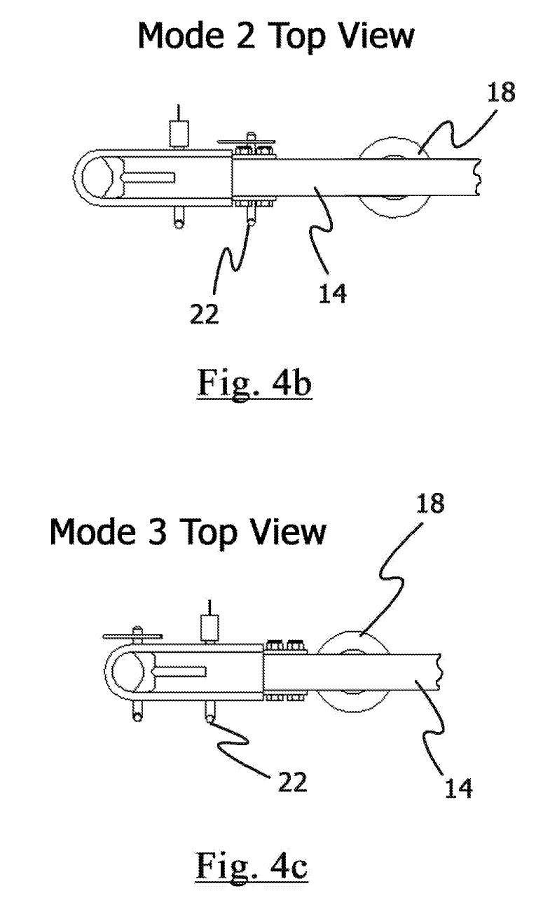

Referring now to FIG. 1a, a side perspective view of one exemplary embodiment of coupler converter (10) is presented in a first converter-coupler-mode where the Lunette ring (18) is used to associate trailer (9) to a tow vehicle. FIG. 3a is a side view of such first mode/configuration and FIG. 4a presents a top view of such first mode/configuration. As best viewed in FIG. 2, for the first coupler mode, c-body interface (33) is placed in alignment with attachment point (34) and c-body interface (31) is placed in alignment with attachment point (32) and pins (22) and (24) are used to removably and mechanically associate coupler body (11) with interface plates 16a and (16b).

Referring now to FIG. 1b, a side perspective view of one exemplary embodiment of coupler converter (10) is presented in a second converter-coupler-mode where the coupler ball socket (26) is used to associate trailer (9) to a tow vehicle. FIG. 3b is a side view of such first configuration and FIG. 4b presents a top view of such first configuration. For the second coupler mode, c-body interface (33) is placed in alignment with attachment point (32) and c-body interface (31) is placed in alignment with attachment point (34) and pins (22) and (24) are used to removably and mechanically associate coupler body (11) with interface plates 16a and (16b) so that coupler converter (10) is stowed under drawbar (14) and ball socket (26) is used to associated trailer (90 with a tow vehicle).

Referring now to FIG. 1c, a side perspective view of one exemplary embodiment of coupler converter (10) is presented in a third converter-coupler-mode where neither the coupler ball socket nor the Lunette ring is used to associate trailer (9) to a tow vehicle. FIG. 3c is a side view of such first configuration and FIG. 4c presents a top view of such first configuration. For the third coupler mode, c-body interface (31) is placed in alignment with attachment point (32) with the second end (11e) of coupler body (11) blocking ball socket (26). It will be appreciated by one of ordinary skill in the art that such configuration provides a security feature by preventing the normal use of either the ball socket (26) or the Lunette ring (18). Such security feature is enhanced by using a pin locking device 24 as shown in FIG. 2. Such devices are well known in the art and a detailed description thereof is not necessary to provide an enabling description of the invention.

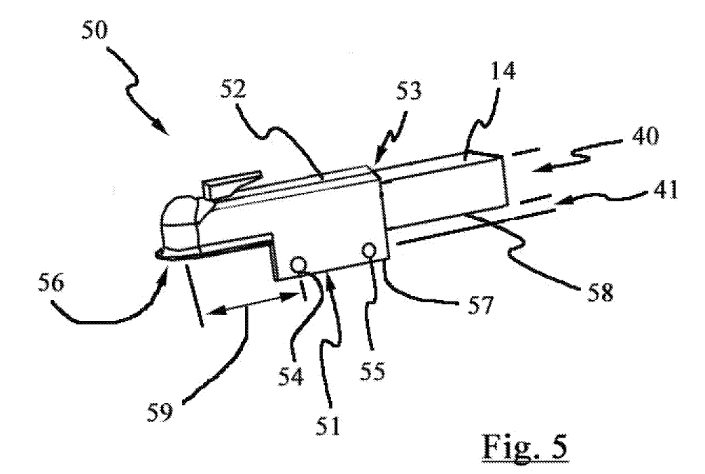

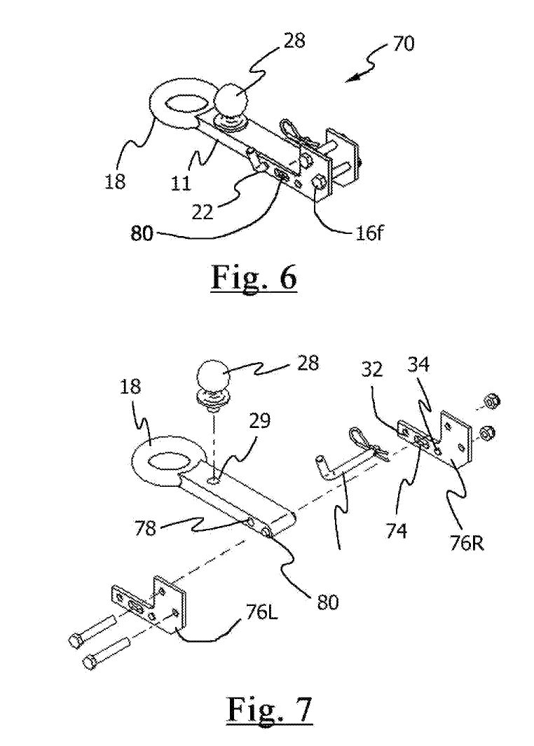

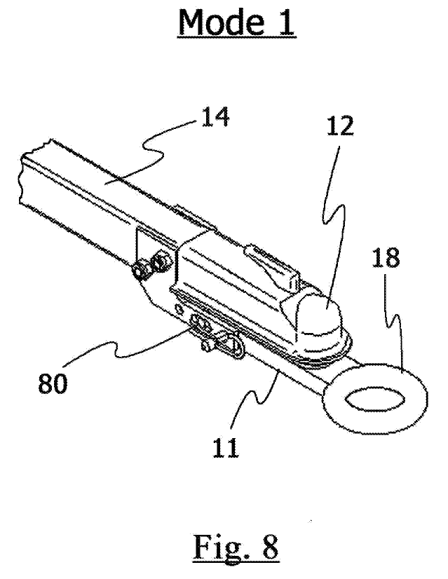

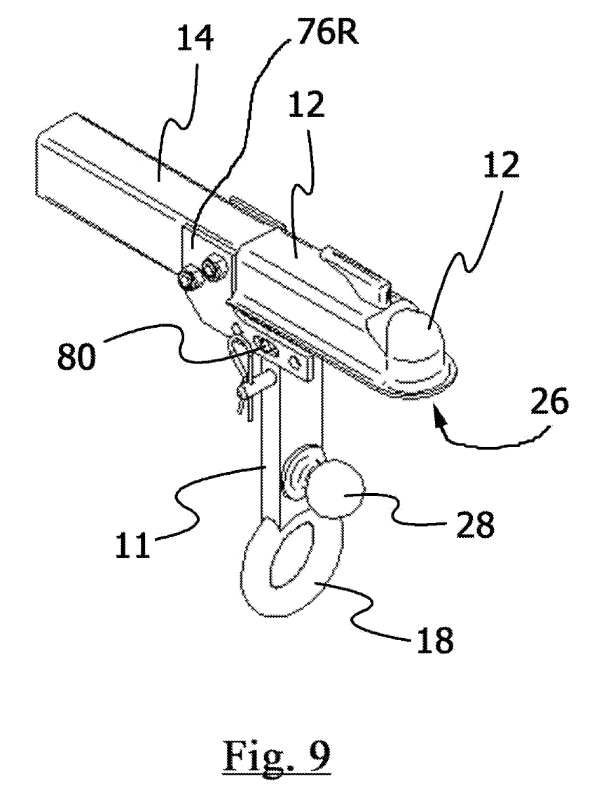

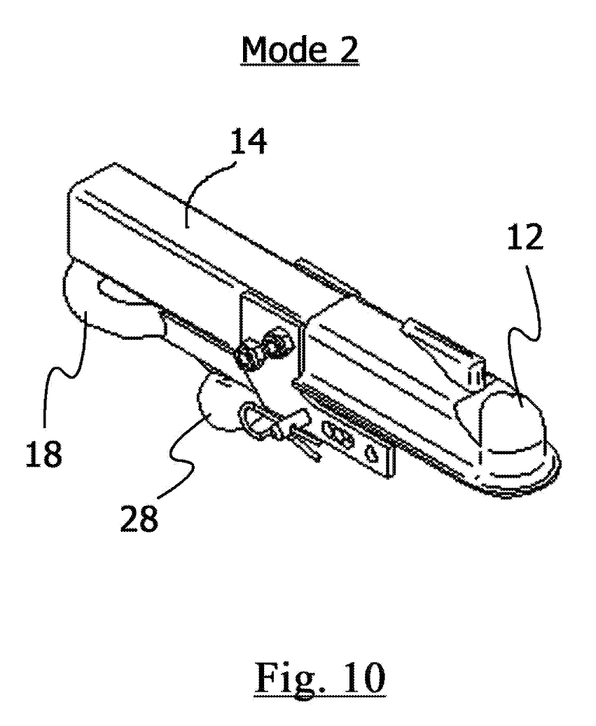

Referring now to FIG. 2, an exploded view of one exemplary embodiment of a coupler converter (10) is presented. For the presently preferred embodiment of the invention, coupler convertor (10) comprises optional interface-plates (16a) and (16b). It should be appreciated that such interface-plates are preferably used with trailers preconfigured with a standard prior art coupler type as depicted in FIG. 1. For some configurations, the interface plates may be integral to the vehicle to be towed or integral to coupler (12). As described later, one embodiment of the invention includes a coupler (12) having the functionality of interface-plates (16a) and (16b) integrated into coupler (12) (see FIG. 5). For the presently preferred embodiment depicted in FIG. 2, interface-plates (16a) and (16b) are secured to the coupler support structure (i.e. drawbar 14) of trailer (9) by attachment devices (160 (nuts and bolts for this embodiment). Alternatively, the attachment plates may be associated with trailer (9) by any other suitable methods such as welding, pins, and clamps.

For the preferred embodiment depicted in FIG. 2, coupler converter (10) comprises an elongated rectangular shaped converter body (11) defining at first end and an opposing distal second end (11e). Converter-body-coupler (18) is associated with said first end. At least one c-body interface [such as c-body interface (31) and/or c-body interface (33)] is disposed between the first-end and said distal second end (11e). For the embodiment depicted in FIG. 2, converter body (11) defines a rectangular bar having the following approximate dimensions: thickness=X, width=2X, and length=10X (e.g. 1″ thick, 2″ wide, and 10″ long).

For the embodiment depicted in FIG. 2, converter-body (11) defines two c-body interfaces (holes through the width of converter-body (11)); c-body interface (31), and c-body interface (33). As noted above, any number of c-body interfaces may be used. The c-body interfaces are configured for being removably associated with one of (a) at least one attachment point defined by a coupler (see FIG. 5), and (b) at least one attachment point defined by interface-plates (16a) and (16b). Interface-plates (16a) and (16b), define two attachment points, attachment point (32) and attachment point (34) configured for being associating with converter body (11) via c-body-interface (31) and c-body-interface (33) via pins (22) and pins (24). One of ordinary skill in the art will appreciate that such a configuration provides for a “removable association” that does not require tools to achieve the separation of converter body (11) from its association with trailer (9). It is noted that just about any two items can be removed/separated from each other using tools. For example, welds can be cut with a cutting torch, bolts can be removed with wrenches, and rivets can be cut and removed. For the purposes of this document, two items are removably associated if they can be separated without destroying/damaging one of the items to the point that the damaged item requires significant repairs or becomes unusable. Similarly, two items are removably associated without the use of tools if no tools are required to separate the two items. For example, the pins in FIG. 2 can be removed without the use of tools. Additionally, for the purposes of this document, a “key” to unlock lock (24) is not a “tool”.

Converter body (11) is further associated with optional converter-to-coupler attachment mechanism (28). The converter-to-coupler attachment mechanism (28) is suitable for being mechanically associated with the first coupler type (ball socket 26, see FIG. 1b) defined by said coupler (12). Restated, converter-to-coupler attachment mechanism (28) is preferably suitable for being associated with the original coupler (ball socket) associated with trailer (9) as if the converter coupler (10) were the tow vehicle. For example, converter-to-coupler attachment mechanism (28) is a ball hitch suitably sized to mechanically associate with coupler ball socket (26). Other types of converter-to-coupler attachment mechanisms may be used without departing from the scope and spirit of the invention (such as devices that extent into the coupler socket 26 and lock into place). Additionally, it should be appreciated that embodiments not including a converter-to-coupler attachment mechanism fall within the scope of the invention.

### Coupler with Integral Converter Interface

Referring now to FIG. 5, an improved coupler (50) for coupling a vehicle to be towed (VTBT) to a tow vehicle is presented. Coupler (50) comprises a coupler body (52) defining a support-structure-interface (53) suitably configured for being mechanically associated with a support structure (14) associated with a VTBT. For the embodiment depicted in FIG. 5, support structure (14) is a drawbar and the support-structure-interface (53) is a portion of the inside surface of coupler (50). Coupler (50) further defines a coupler-mechanism (56) suitably sized for being associated with a tow-point associated with a tow vehicle. For the presently preferred embodiment, coupler-mechanism (56) is a ball socket and the tow-point is a ball hitch such as those typically found associated with the rear bumpers of trucks.

Coupler body (52) further defines a converter-interface section (51) defining at least one converter-attachment-point. For the presently preferred embodiment depicted in FIG. 5, coupler body (52) defines converter-attachment-point (54) and converter-attachment-point (55). The converter-attachment-points are configured for being removably associated with a converter-coupler such as converter-coupler (10) described above. For the presently preferred embodiment, converter-attachment-point (54) and (55) are holes for receiving attachment means such a pins or bolts.

For the preferred embodiment, the converter-interface section (51) is at least the region of the coupler body (53) that extends beyond support structure (14) as defined by gap (41). Additionally, converter-attachment-points (54) and (55) are disposed in converter-interface section (51) so that a converter coupler can be associated with coupler (50) in at least two configurations as described above.

### C-Clamp Configuration

FIG. 13 presents a coupler converter (10) comprising a converter body (11) associated with a converter-body-coupler (18), a converter-to-coupler attachment mechanism (28), and a c-clamp stabilizer. For such alternative embodiment, coupler converter (10) provides for a clamping feature to add stability to the system by limiting up/down movement of the second end of coupler body (11). Similar to the previous configurations described above, second end defines c-body interfaces (80b) configured to receive a leg of c-clamp (90) and secured in place by bolt (91). For this configuration, converter-to-coupler attachment mechanism (28) is inserted into the ball socket (26) of a coupler. C-clamp (90) is installed over drawbar (14) and inserted into c-body interface (80b) [one for each side] and secured in place by bolt (91).

### No C-Body Interfaces

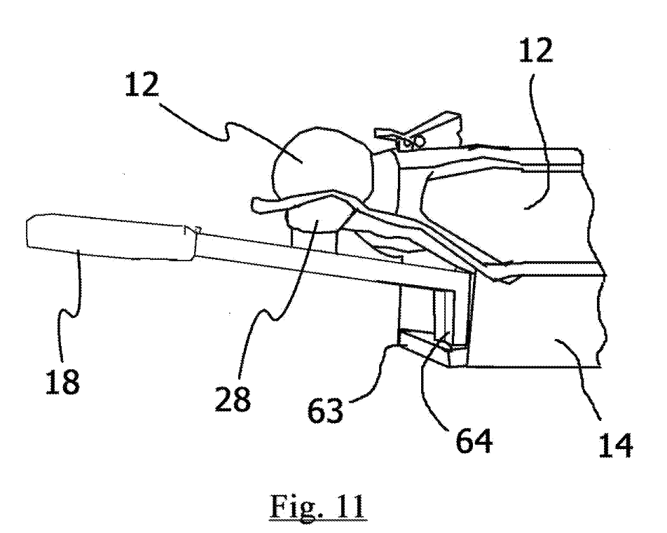

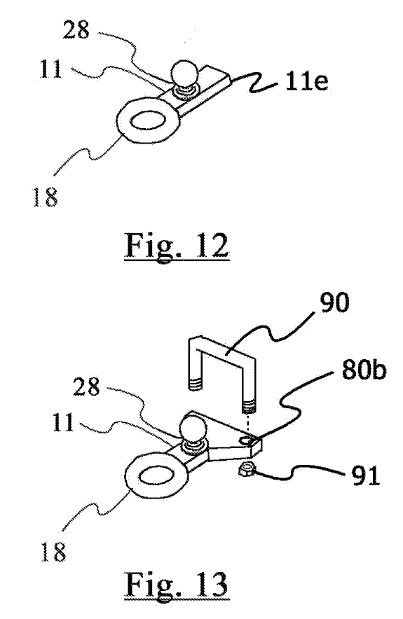

Referring now to FIG. 11 and FIG. 12, two alternative embodiments of the invention are presented. For the embodiment depicted in FIG. 11, converter-coupler (10) comprises a converter body (11) associated with a converter-body-coupler (18) and a converter-to-coupler attachment mechanism (28). Unlike the previous configurations, converter body (11) does not define c-body interfaces disposed between the first-end and the distal second end of converter body (11). For this configuration, second end defines body-stop (64) configured to press against a support surface (63) to provide better stability.

Referring now to FIG. 12, converter-coupler (10) comprises a converter body (11) associated with a converter-body-coupler (18) and a converter-to-coupler attachment mechanism (28). Unlike the previous configurations, converter body (11) does not define c-body interfaces disposed between the first-end and the distal second end of converter body (11).

### Adjustable Coupler Converter

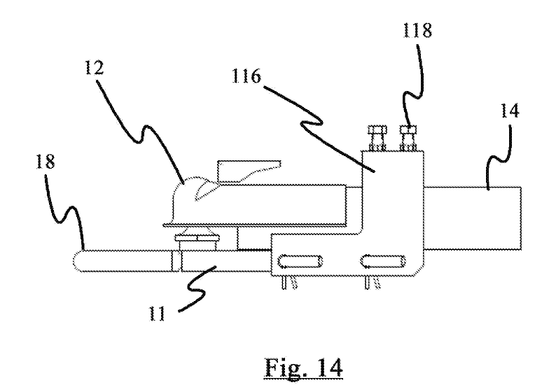

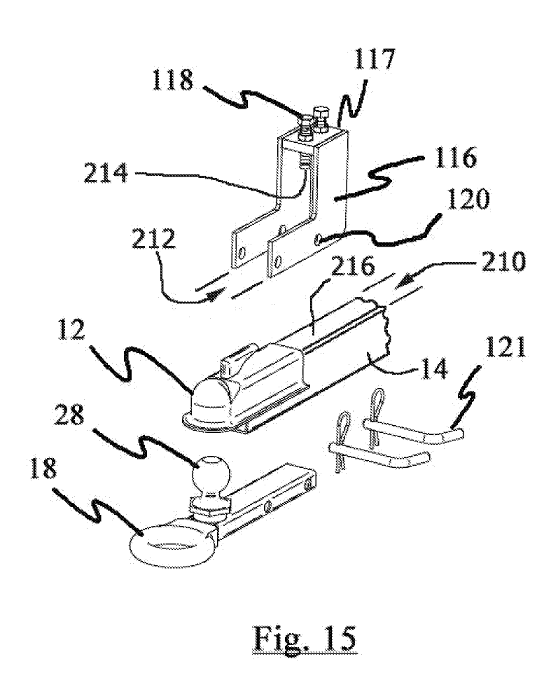

Referring now to FIG. 14 and FIG. 15, yet another alternative embodiment of the invention is presented providing for an adjustable coupler converter. The adjustable coupler converter converts the VTBT-coupler (Vehicle To Be Towed) defining a first coupler type, to a second coupler type as described previously. As before, the adjustable coupler converter comprises a converter body (11) defining a first end and a distal opposing second end. The first end of converter body (11) either defines a converter-body-coupler (28) or is mechanically associated with said converter-body-coupler (28). Converter-body-coupler (28) defines a second coupler type and is suitable for being mechanically associated with a hitch associated with a tow vehicle;

The adjustable coupler converter further comprises converter interface (116). Converter-interface (116) comprises a left side and a right side, each of said left side and said right side defining an “L” shape, wherein said left side and said right side are joined at the top of the “L” by a cross-member (117). As depicted in FIG. 15, for the presently preferred embodiment of the invention, cross-member (117) is aligned horizontally relative to said left side and said right side, wherein said cross-member (117) is configured to provide a predefined width-distance (212) between said left and said right side. One of ordinary skill in the art will appreciated that width-distance (212) should be slightly greater than the width (210) of said support structure (14).

For the currently preferred embodiment, interface-plates (16a) and (16b) (from the previous configurations discussed above) are integrated into a “one piece component”, converter interface (116). Converter Interface (116) is basically two “L” shaped brackets joined at the top of the “L” by a cross-member (117). The “one piece” converter interface (116) may be a cross-member (117) welded to the top of the “L” shaped brackets as depicted in FIG. 15 to form a “one piece component”. Alternatively, converter interface (116) may be a forged piece of metal having two “L” shaped sides connected at the top of the “L” by a cross section. Cross-member (117) is further configured to receive a vertical-adjustor (118) configured to provide the adjustment feature of the current embodiment of the invention. Vertical-adjustor (118) is configured to adjust the distance between said cross-member (117) and support structure (14). For the current embodiment, vertical-adjustor (118) is a pair of screws (118) (although any number of screws may be used). While screws are used in the preferred embodiment, any number of “adjustment schemes” may be used without departing from the scope and spirit of the present invention (i.e. springs, slotted bars, etc.). The bottom (214) of screws (118) push against surface (216) of support structure (14) when the converter interface is associated with support structure (14) as depicted in FIG. 14 and FIG. 15. Rotating screws (118) will move cross-member (117) either closer or further away from surface (116) (depending on the direction of rotation). Such a feature allows the adjustable coupler converter to be used on vehicles having a range of support structure (14) sizes.

Converter Interface (116) further defines at least one converter-attachment-point (120) configured for removably mechanically associating said converter-interface (116) with converter body (11). For the embodiment depicted in FIG. 15, converter interface (116) defines two converter-attachment-point (120) pairs configured for aligning with holes defined by converter body (11) and receiving pins (121). While attachment points (120) are depicted as holes, any type of suitable attachment point may be used for receiving pins such as slots. Notably, properly aligned slots can allow for forward and backward adjustments in addition to the un/down adjustments allowed by vertical-adjustor (118). As shown FIGS. 14 and 15, interface (116) further defines a plurality of attachment points (120) configured for receiving pins (120).

As with the previous described configuration, the adjustable coupler converter preferably allows for a plurality of coupling modes. Such plurality of modes feature is provided by Converter-interface (116) when configured with a plurality of attachment points. In a first coupling mode, the converter-to-coupler attachment mechanism (28) is mechanically associated with said first coupler type (12) and the converter-body-coupler (18) is configured for associating said VTBT to a tow vehicle. Similarly, for a second coupling mode, the first coupler type (12) defined by said coupler is configured for associating the VTBT to a hitch associated with a tow vehicle and the converter body is stowed under the support structure. Such coupling modes were described in detail earlier in this document.

One of ordinary skill in the art will appreciate that the exemplary embodiment of the invention depicted in FIGS. 14 and 15 may be associated with a trailer without the need for drilling holes in the trailer or welding.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

What is claimed is:

1. A coupler converter for converting a coupler defining a first coupler type to a second coupler type, said coupler associated with a vehicle to be towed (VTBT), said coupler converter comprising:
a converter body configured for being mechanically associated with a coupler associated with a VTBT, said coupler defining a first coupler type; and
a converter-body-coupler that is one of (a) mechanically associated with said converter body, and (b) integral to said converter body, said converter-body-coupler defining a second coupler type, said converter-body-coupler suitable for being mechanically associated with a hitch associated with a tow vehicle.

2. A coupler converter as in claim 1, further comprising a converter-to-coupler attachment mechanism associated with said converter body, wherein said converter-to-coupler attachment mechanism is suitable for being mechanically associated with said first coupler type when said converter-body-coupler is used to associate said VTBT to a tow vehicle thereby defining a first converter mode.

3. A coupler converter as in claim 2, wherein said converter-coupler is a lunette ring and said converter-to-coupler attachment mechanism is a trailer ball hitch suitably sized for being received by the first coupler type.

4. A coupler converter as in claim 2, wherein said converter body defines a rectangular shaped body comprising a first end associated with said lunette ring, said converter body extending from said first end to an opposing distal second end, and wherein said converter body further defines a c-body interface disposed between said first end and said distal second end, said c-body interface suitable for being removably associated with one of (a) at least one attachment point defined by said coupler, and (b) at least one attachment point defined by an attachment-plate mechanically associated with said VTBT.

5. A coupler converter as in claim 4, wherein no tools are required to remove the association between said c-body interface and said attachment point.

6. A coupler converter as in claim 4, wherein said c-body interface is disposed along said converter body to provide for a first converter-coupler-mode where the converter-to-coupler attachment mechanism is associated with the first coupler type defined by said coupler and said converter-body-coupler is used for associating the VTBT to a hitch associated with a tow vehicle.

7. A coupler converter as in claim 6, wherein said c-body interface is disposed along said converter body to provide for a second converter-coupler-mode where the converter-to-coupler attachment mechanism is not associated with the first coupler type defined by said coupler and said first coupler type is used for associating the VTBT to a hitch associated with a tow vehicle.

8. A coupler converter as in claim 7, wherein said c-body interface is disposed along said converter body to provide for a third converter-coupler-mode where neither the first coupler type defined by said coupler nor the converter-body-coupler is used for associating the VTBT to a hitch associated with a tow vehicle and interferes with the normal use of said first coupler type and said converter-body-coupler thereby providing a security feature.

9. A coupler for coupling a vehicle to be towed (VTBT) to a tow vehicle, said coupler:
a coupler body defining a support-structure-interface suitably configured for being associated with a support structure associated with a VTBT;
a coupler-mechanism that is one of (a) associated with said coupler body and (b) integral to said coupler body, said coupler-mechanism suitably sized for being associated with a first hitch type; and
wherein said coupler body further defines a converter-interface section defining at least one converter-attachment-point.

10. A coupler for coupling a VTBT to a tow vehicle as in claim 9, wherein said coupler-mechanism is a ball-hitch socket.

11. A coupler for coupling a VTBT to a tow vehicle as in claim 9, wherein the location of said at least one converter-attachment-point within said converter-interface section is positioned to allow a converter-coupler comprising a converter-body-coupler to be associated with said coupler in a first mode where said converter-body-coupler is used to associate said VTBT to a tow vehicle.

12. A coupler for coupling a VTBT to a tow vehicle as in claim 11, wherein said location of said at least one converter-attachment-point further provides for a second mode wherein the coupler-mechanism is used to associate the VTBT to a tow vehicle.

13. A coupler for coupling a VTBT to a tow vehicle as in claim 12, wherein said location of said at least one converter-attachment-point further provides for a third mode wherein neither a converter-coupler nor the coupler-mechanism is used to associate said VTBT to a tow vehicle thereby providing a security feature.

14. A coupler for coupling a VTBT to a tow vehicle as in claim 12, wherein said location of said at least one converter-attachment-point further allows said converter-coupler to pivot about said at lest one converter-attachment-point to select one of said first mode and said second mode.

15. An adjustable coupler converter for converting a VTBT-coupler (Vehicle To Be Towed) defining a first coupler type to a second coupler type, said VTBT-coupler associated with said VTBT by a support structure, said coupler converter comprising:
a converter body;
a converter-body-coupler that is one of (a) mechanically associated with said converter body, and (b) integral to said converter body, said converter-body-coupler defining a second coupler type, said converter-body-coupler suitable for being mechanically associated with a hitch associated with a tow vehicle;
a converter-interface comprising a left side and a right side, each of said left side and said right side defining an “L” shape, wherein said left side and said right side are joined at the top of the “L” by a cross-member, said cross-member aligned horizontal relative to said left side and said right side, wherein said cross-member is configured to provide a predefined width-distance between said left and said right side, wherein said predefined width-distance is greater than the width of said support structure;
wherein said converter-interface defines at least one converter-attachment-point configured for removably mechanically associating said converter-interface with said converter body; and
wherein said cross-member is further configured to receive a vertical-adjustor configured to adjust the distance between said cross-member and said support structure.

16. An adjustable coupler converter as in claim 15, wherein said left side, said right side and said cross-member are one integral component.

17. An adjustable coupler converter as in claim 15, wherein said converter-interface further defines a plurality of attachment points configured for configuring said adjustable coupler converter in a plurality of coupling modes.

18. An adjustable coupler converter as in claim 17, wherein said plurality of coupling modes includes a first coupling mode wherein said converter-to-coupler attachment mechanism is mechanically associated with said first coupler type and said converter-body-coupler is configured for associating said VTBT to a tow vehicle.

19. An adjustable coupler converter as in claim 18, wherein said converter-coupler is a lunette ring and said converter-to-coupler attachment mechanism is a trailer ball hitch suitably sized for being received by the first coupler type.

20. An adjustable coupler converter as in claim 19, wherein said plurality of coupling modes includes a second coupling mode wherein the first coupler type defined by said coupler is configured for associating the VTBT to a hitch associated with a tow vehicle and the converter body is stowed under the support structure.
